(19) United States
(12) Patent Application Publication
(10) Pub. No.: US 2018/0025843 A1
(43) Pub. Date: Jan. 25, 2018

(54) METHOD OF MANUFACTURING CAPACITOR BASE MATERIAL HAVING HIGH ENERGY STORAGE EFFICIENCY

(71) Applicant: KSFL CO., LTD., Taipei City (TW)

(72) Inventor: RONG-SAN LIN, Taipei City (TW)

(21) Appl. No.: 15/214,404

(22) Filed: Jul. 19, 2016

(51) Int. Cl. H01G 4/30

(52) U.S. Cl. CPC H01G 4/306

(57) ABSTRACT

A method of manufacturing a capacitor base material having high energy storage efficiency, which includes the following steps: placing at least one base material and at least one plating liquid; spray-coating the plating liquid on the surface by an electrospinning spray manner, to stack the plating liquid on the surface of the base material in a form of nano-sized beads; performing a sintering process on the base material coated with the plating liquid; completing the capacitor base material. The capacitor base material has a film formed by stack of a plurality of nano-sized beads at the surface thereof, and gaps exist between the plurality of nano-sized beads. Therefore, by utilizing the capacitor base material which has stack of and intervals between the plurality of nano-sized beads formed on the surface thereof, the capacitor base material can have higher specific surface area.

### BACKGROUND OF THE INVENTION

### (a) Technical Field of the Invention

The present disclosure relates to a method of manufacturing a capacitor base material having high energy storage efficiency, In particular, to utilize an electrospinning spray manner to spray coat a plating liquid on a surface of the base material, to stack nano-sized beads and form intervals between the nano-sized beads on the surface of the capacitor base material, so as to obtain higher specific surface area. Therefore, the increasing of the charge storage energy can be achieved by adsorbing more cations and anions of the electrolytic solution.

### (b) Description of the Prior Art

A traditional method of manufacturing capacitor base material mainly adopts dip coating-sintering. Because traditional dip coating-sintering can obtain quickly ruthenium oxide electrode without complex apparatus configuration and complex technology flow, the dip coating-sintering is widely applied. The ruthenium oxide electrode obtained by the traditional dip coating-sintering has crystallinity and is a structure of anhydrous ruthenium oxide. The capacitance effect works between fissures, cracks of the crystals, and the crystal fissure structure is a planar structure.

However, the problem to be solved in the traditional dip coating-sintering is the too low specific surface area which causes the generated capacitance effect is no longer adequate for the meed in application end. The reason is that the crystal fissure structure of the ruthenium oxide electrode obtained by the traditional dip coating-sintering is a plane structure which results in capacitance just being generated and existed in the crack but not the crystal area having no crack. Therefore, in order to increase the capacitance, traditional dip coating-sintering increase the times of dip coating. Although the capacitance increases correspondingly, the instability of the structure starting to break occurs with increasing of times of dip coating.

In addition, because the crystal structure is very dense, the traditional dip coating-sintering has limited improvement in capacitance. The capacitor effect of the capacitor made from metal oxide, Ruthenium, comes depends on two factors. One factor is the electric double layer (EDL) effect which is generated by attraction between positive charges and negative charges. The other factor is the pseudo oxidation-reduction reaction which is also called pseudo capacitance. The ruthenium belongs group of the transition metal element, and such element is characterized in various electrons in the outermost shell, being easy to lost electron and gain electron. After the capacitor is charged, the ruthenium is bonded with the hydrogen ion in the electrolytic solution by generating coordinate bond temporarily. During process of charging and discharging, mass charge transmissions are generated, and most capacitances of ruthenium oxide is caused by such reaction. However, the problem of dense structure is that ions in the electrolytic solution can move deep into the crack of the lower coating layer for reaction, but only can act between the surfaces of the electrode in the higher coating layer. The ions in the electrolytic solution are hard to move deep into the deeper layer due to its dense structure, so the capacitance is hard to increase efficiently. During charging, the positive electrode terminal is at high voltage, so the ions are hard to enter the deeper layer and a bias status is formed, particularly to the positive terminal of the first layer. The bulging of the positive electrode terminal may occur after long time, it means the capacitor is at a danger stage about threshold of blowing up.

### SUMMARY OF THE INVENTION

In order to solve the problems and the defects in the traditional technology, the present disclosure illustrates a method of manufacturing a capacitor base material having high energy storage efficiency, and the method comprises the following steps. Placing at least one base material and at least one plating liquid; spray-coating the plating liquid on the surface by an electrospinning spray manner, to stack the plating liquid on the surface of the base material in a form of nano-sized beads; performing a sintering process on the base material coated with the plating liquid; completing the capacitor base material. The capacitor base material has a film formed by stack of a plurality of nano-sized beads at the surface thereof, and gaps exist between the plurality of nano-sized beads. Therefore, by utilizing the capacitor base material which has stack of and intervals between the plurality of nano-sized beads formed on the surface thereof, the capacitor base material can have higher specific surface area. In the back-end process of manufacturing the capacitor, more cations and anions of the electrolytic solution can be adsorbed to achieve the increasing of the charge storage energy.

### BRIEF DESCRIPTION OF THE DRAWINGS

The detailed structure, operating principle and effects of the present disclosure will now be described in more details hereinafter with reference to the accompanying drawings that show various embodiments of the present disclosure as follows.

FIG. 1 is a flow diagram of a manufacturing process of the present disclosure.

FIG. 2 is an enlarged local view of film structural of a capacitor base material of the present disclosure.

### DETAILED DESCRIPTION OF THE PREFERRED EMBODIMENTS

Reference will now be made in detail to the exemplary embodiments of the present disclosure, examples of which are illustrated in the accompanying drawings. Therefore, it is to be understood that the foregoing is illustrative of exemplary embodiments and is not to be construed as limited to the specific embodiments disclosed, and that modifications to the disclosed exemplary embodiments, as well as other exemplary embodiments, are intended to be included within the scope of the appended claims. These embodiments are provided so that this disclosure will be thorough and complete, and will fully convey the inventive concept to those skilled in the art. The relative proportions and ratios of elements in the drawings may be exaggerated or diminished in size for the sake of clarity and convenience in the drawings, and such arbitrary proportions are only illustrative and not limiting in any way. The same reference numbers are used in the drawings and the description to refer to the same or like parts.

It will be understood that, although the terms ‘first’, ‘second’, ‘third’, etc., may be used herein to describe various elements, these elements should not be limited by these terms. The terms are used only for the purpose of distinguishing one component from another component. Thus, a first element discussed below could be termed a second element without departing from the teachings of embodiments. As used herein, the term “or” includes any and all combinations of one or more of the associated listed items.

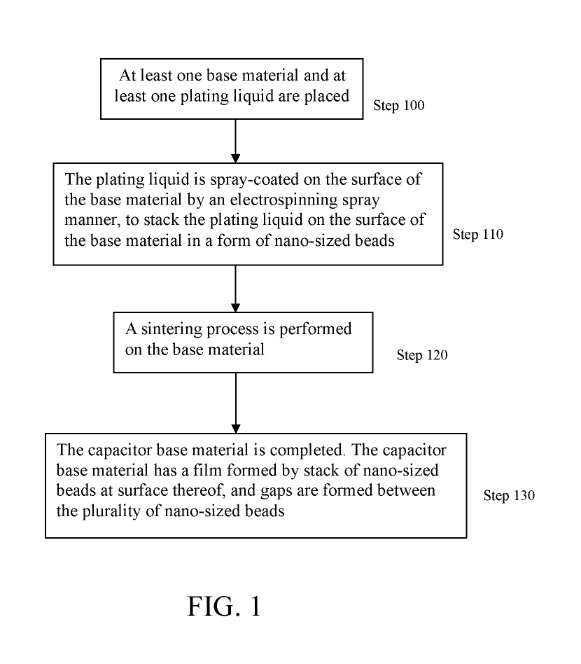

The present disclosure illustrates a method of manufacturing a capacitor base material having high energy storage efficiency. Please refer to FIG. 1 which is a flow diagram of manufacturing process of the present disclosure. The method comprises the following steps.

In step 100, at least one base material and at least one plating liquid are placed. Preferably, the base material is titanium (Ti). Preferably, the material of the plating liquid can be ruthenium dioxide, a mixing of ruthenium dioxide and graphene, or a mixing of ruthenium dioxide and conductive macromolecule.

In step 110, the plating liquid is spray-coated on the surface of the base material by an electrospinning spray manner, to stack the plating liquid on the surface of the base material in a form of nano-sized beads. The plating liquid is placed in an electrospinning apparatus, and the electrospinning apparatus utilizes a high voltage to generate voltage drop to manufacture nano substance, whereby the electrospinning spray manner is utilized to spray and stack the plating liquid on the surface of the base material in a form of nano-sized beads.

In step 120, a sintering process is performed on the base material. The sintering process is performed on the base material which has spray-coated and stacked nano-sized beads on the surface thereof.

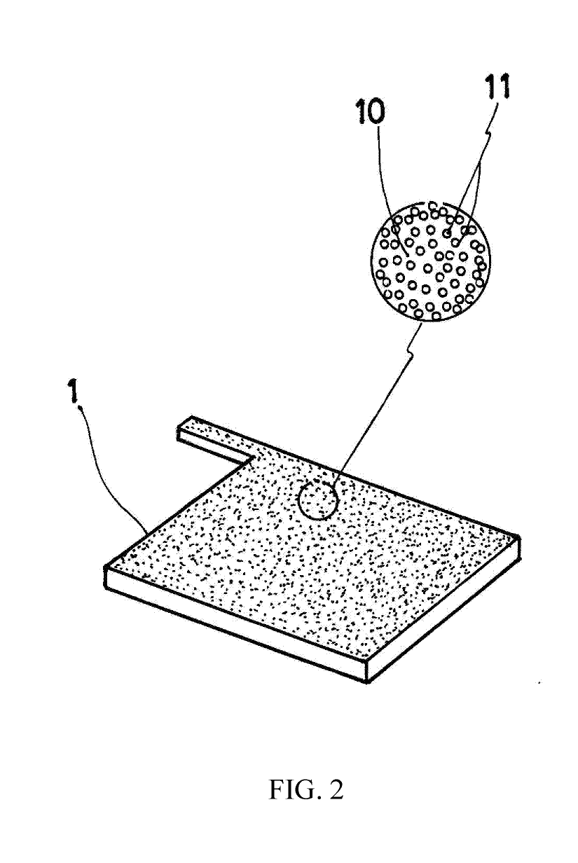

In step 130, the capacitor base material 1 is completed. The capacitor base material 1 has a film formed by stack of nano-sized beads 11 at surface thereof, and gaps 10 are formed between the plurality of nano-sized beads 10, as shown in FIG. 2.

By utilizing the capacitor base material 1 which has stack of and intervals 10 between a plurality of nano-sized beads 11 formed on the surface thereof, the capacitor base material 1 can have higher specific surface area.

In back-end process of manufacturing the capacitor, the capacitor base material 1 can adsorb more cations and anions in the electrolytic solution by the plurality of nano-sized beads 11 formed on the surface of the capacitor base material 1 and the intervals 10 between the plurality of nano-sized beads 11, so that charge storage energy can be increased.

In addition, the capacitor base material 1 which adsorbs cation and anion already can be made in two or more stacks to form a capacitor, and a positive conductive contact point and a negative conductive contact point are disposed in the capacitor. The capacitor base material 1 can be arbitrary shape, whereby the capacitor in arbitrary shape can be formed by two or more stacks of the capacitor base material 1. For example, the capacitor can be made in a shape of cell phone casing structure.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

I claim:

1. A method of manufacturing a capacitor base material having high energy storage efficiency, comprising:
placing at least one base material and at least one plating liquid;
spray-coating the plating liquid on the surface by an electrospinning spray manner, to stack the plating liquid on the surface of the base material in a form of nano-sized beads;
performing a sintering process on the base material; and
completing the capacitor base material having a film formed by stack of nano-sized beads at the surface thereof, gaps existing between the nano-sized beads.

2. The method according to claim 1, wherein the base material is titanium.

3. The method according to claim 1, wherein material of the plating liquid is ruthenium dioxide.

4. The method according to claim 1, wherein material of the plating liquid is a mixing of ruthenium dioxide and graphene.

5. The method according to claim 1, wherein material of the plating liquid is a mixing of ruthenium dioxide and conductive macromolecule.

6. The method according to claim 1, wherein the capacitor base material is made in two or more stacks to form a capacitor.

7. The method according to in claim 6, wherein the capacitor has arbitrary shape.
